(19) United States
(12) Patent Application Publication
(10) Pub. No.: US 2026/0296142 A1
(43) Pub. Date: Oct. 1, 2026

(54) UNIT COOLER

(71) Applicant: KABUSHIKI KAISHA TOYOTA JIDOSHOKKI, Kariya-shi (JP)

(72) Inventors: Ryota Watanabe, Kariya-shi (JP); Hisaya Kondo, Kariya-shi (JP); Kengo Sakakibara, Kariya-shi (JP); Shun Kubota, Kariya-shi (JP); Hiromichi Ogawa, Kariya-shi (JP)

(73) Assignee: KABUSHIKI KAISHA TOYOTA JIDOSHOKKI, Kariya-shi (JP)

(21) Appl. No.: 19/569,042

(22) Filed: Mar. 17, 2026

(30) Foreign Application Priority Data
Mar. 28, 2025 (JP) 2025-057068

(51) Int. Cl. B60H 1/32; B60H 1/00

(52) U.S. Cl. CPC B60H 1/3229; B60H 1/00357; B60H 1/3222; B60H 2001/3286

(57) ABSTRACT

A unit cooler includes a housing, an air conditioning unit, and a duct. The air conditioning unit is accommodated in the housing. The duct is disposed in the housing and through which the air cooled by the air conditioning unit is discharged. The duct is a bellows device having one end portion and the other end portion. The bellows device allows the cooled air to be drawn through the one end portion, to flow through an inside of the bellows device, and to be discharged from the other end portion. The bellows device is extendible and contractible so that a distance between the one end portion and the other end portion is changed. The one end portion is fixed to an inside of the housing, and at least a portion of the other end portion is retracted to the inside of the housing when the bellows device is most contracted.

### CROSS-REFERENCE OF THE RELATED APPLICATION

This application claims priority to Japanese Patent Application No. 2025-057068 filed on Mar. 28, 2025, the entire disclosure of which is incorporated herein by reference.

### BACKGROUND ART

The present disclosure relates to a unit cooler.

Japanese Patent Application Publication No. 2024-152229 discloses a conventional unit cooler. This unit cooler is used in an industrial vehicle such as a forklift truck that has a power supply.

This unit cooler includes a housing and an air conditioning unit. The housing has an intake port through which air is drawn and an outlet port from which the air drawn through the intake port is discharged. The air conditioning unit is accommodated in the housing, forms a refrigerant cycle, cools air that is drawn through the intake port, and discharges the cooled air through the outlet port. The air conditioning unit has an electric compressor, a condenser, a decompression device, and an evaporator. In addition, the air conditioning unit has a first fan that rotates to send air to the condenser and a second fan that rotates to send air to the evaporator. The electric compressor is disposed between the condenser and the evaporator. The first fan is disposed between the electric compressor and the condenser, and the second fan is disposed between the electric compressor and the evaporator.

The first fan sends the air drawn through the intake port to the condenser, thereby releasing heat from the condenser. In addition, the second fan sends the air drawn through the intake port to the evaporator to cool the air by heat absorption by the evaporator and to discharge the cooled air from the outlet port. A punkah-louver is provided at the outlet port as a duct, and its air outlet is rotatable as desired. The punkah-louver allows the air flowing through the second fan to be discharged toward a driver outside the housing while changing a direction of air.

However, the above-described conventional unit cooler can change only a direction of the air outlet of the punkah-louver, but cannot change a position of the air outlet. Therefore, even in a case where it is desired to position the air outlet near a neck of the driver of the industrial vehicle, for example, it has been impossible to change the position of the air outlet.

Thus, a bellows device may be used as a duct to supply the cooled air to an outside of the unit cooler, instead of the punkah-louver. The bellows device has one end portion and the other end portion and allows the cooled air to be drawn through the one end portion, to flow through an inside of the bellows device, and to be discharged from the other end portion. In addition, the bellows device is extendible and contractible so that a distance between the one end portion and the other end portion is changed. When the bellows device is used, it is possible to change not only the direction of the air outlet from which the cooled air flows out at the other end portion of the bellows device, but also the position of the air outlet by changing a length of the bellows device. For example, the position of the air outlet may be directed toward the neck of the driver of industrial vehicles and the like.

However, when the bellows device is used, the bellows device tends to bulge downward, whether the duct is in use or not, thereby causing obstruction.

The present disclosure is made in view of the conventional circumstances described above and is directed to providing a unit cooler that does not cause obstruction and is capable of changing a direction and a position of an air outlet as desired.

### SUMMARY

According to one aspect of the present disclosure, there is provided a unit cooler including a housing in which an intake port is formed, an air conditioning unit, and a duct. The air conditioning unit is accommodated in the housing, forming a refrigerant cycle, configured to cool air drawn through the intake port, and configured to discharge the cooled air to an outside of the housing. The duct is disposed in the housing and through which the air cooled by the air conditioning unit is discharged. The duct is a bellows device having one end portion and the other end portion. The bellows device allows the cooled air to be drawn through the one end portion, to flow through an inside of the bellows device, and to be discharged from the other end portion. The bellows device is extendible and contractible so that a distance between the one end portion and the other end portion is changed. The one end portion is fixed to an inside of the housing, and at least a portion of the other end portion is retracted to the inside of the housing when the bellows device is most contracted.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view illustrating a forklift truck on which a unit cooler according to an embodiment is mounted;

FIG. 2 is an exploded perspective view illustrating a housing of the unit cooler according to the embodiment;

FIG. 3 is an exploded perspective view illustrating an air conditioning module of the unit cooler according to the embodiment;

FIG. 4 is a perspective view illustrating the unit cooler according to the embodiment;

FIG. 5 is a schematic horizontal cross-sectional view illustrating the unit cooler according to the embodiment;

FIG. 6 is a schematic vertical cross-sectional view illustrating the unit cooler according to the embodiment;

FIG. 7 is an exploded perspective view illustrating a duct of the unit cooler according to the embodiment; and

FIG. 8 is a cross-sectional view illustrating the duct of the unit cooler according to the embodiment.

### DETAILED DESCRIPTION OF THE EMBODIMENTS

The following will describe an embodiment according to the present disclosure with reference to accompanying drawings.

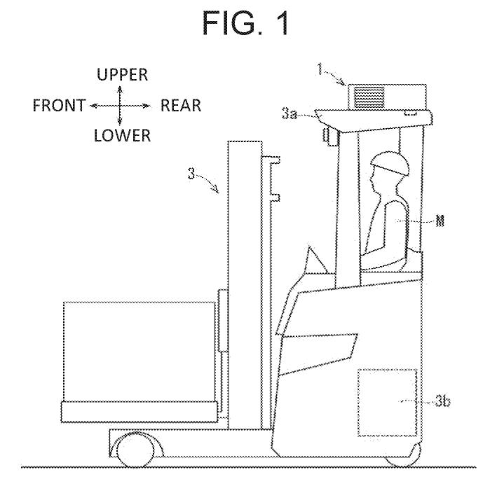

As illustrated in FIG. 1, a unit cooler 1 of the embodiment is fixed to a headguard 3a of a reach-type electric forklift truck 3 as an industrial vehicle. In the following, a front-rear direction, an up-down direction, and a left-right direction of the forklift truck 3 illustrated in FIG. 1 are used for describing directions of the unit cooler 1. The forklift truck 3 includes a battery 3b as an electric power source. When a driver M operates the forklift truck 3, the forklift truck 3 travels and performs cargo handling work by electric power supplied from the battery 3b.

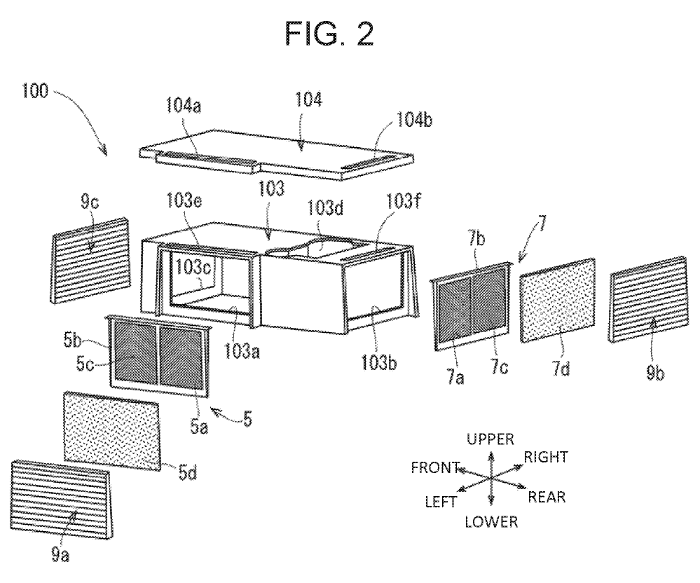

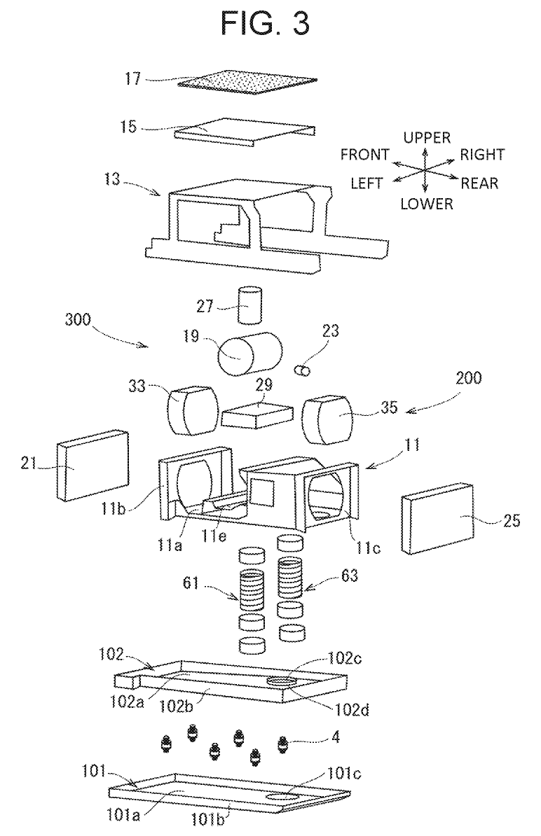

As illustrated in FIGS. 2 and 3, the unit cooler 1 includes a housing 100 and an air conditioning module 300. Note that in FIGS. 2 and 3, illustrations of sealing members or rubber foam are omitted.

The housing 100 includes an outer undertray 101, an inner undertray 102, which are illustrated in FIG. 3, an outer upper cover 103, and an outer top cover 104, which are illustrated in FIG. 2. The outer undertray 101 is made of sheet metal. The inner undertray 102, the outer upper cover 103, and the outer top cover 104 are made of resin.

As illustrated in FIG. 3, the outer undertray 101 includes a bottom plate 101a having a rectangular plate shape extending in the front-rear direction, and a peripheral wall 101b protruding upward from a periphery of the bottom plate 101a. Two outlet ports 101c (only one of which is illustrated in FIG. 3) extend through a rear portion of the bottom plate 101a, which are disposed side by side in the left-right direction. The bottom plate 101a and the peripheral wall 101b each include a plurality of through holes (not illustrated) for assembling the unit cooler 1.

The air conditioning module 300 includes a base frame 11, an upper frame 13, a top frame 15, and an air conditioning unit 200 fixed to these parts. The base frame 11, the upper frame 13, and the top frame 15 are made of sheet metal. A sponge rubber sheet 17 is disposed between the top frame 15 and the outer upper cover 103.

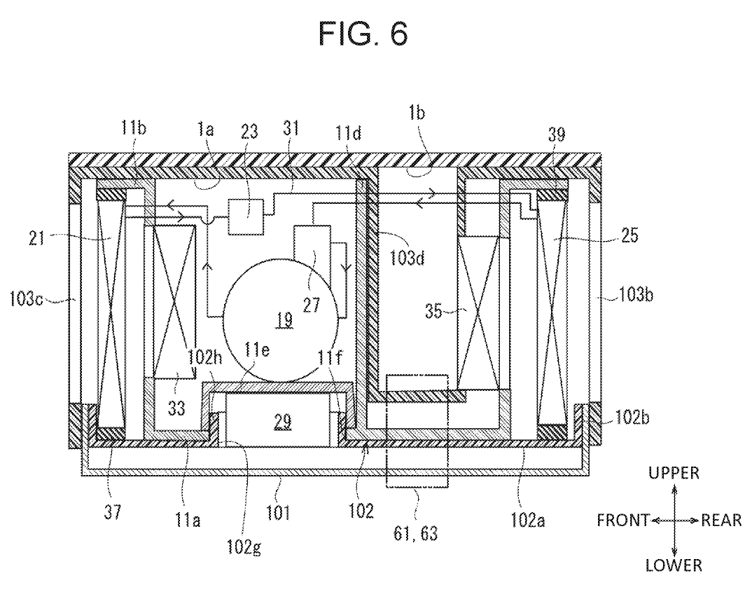

Six vibration-damping members 4, which extend through the inner undertray 102 and have vibration-damping rubber, are provided between the outer undertray 101 and the base frame 11. The inner undertray 102 has a bottom plate 102a having a rectangular plate shape, which is slightly smaller than the bottom plate 101a of the outer undertray 101, and a peripheral wall 102b protruding upward from a periphery of the bottom plate 102a. Outlet ports 102c (only one of which is illustrated in FIG. 3), which are aligned with both outlet ports 101c of the outer undertray 101, respectively, extend through a rear portion of the bottom plate 102a. A standing wall 102d protrudes upward from an inner edge of each of the outlet ports 102c. As illustrated in FIG. 6, a through hole 102g is formed through a front portion of the bottom plate 102a. A section wall 102h is formed in an inner edge of the through hole 102g so as to protrude upward. The inner undertray 102 is configured to receive condensate water generated in an evaporator 25.

As illustrated in FIG. 2, the outer upper cover 103 has a box shape, which is a rectangular parallelepiped box, extends long in the front-rear direction and has an opening in a lower end. In the outer upper cover 103, a first intake port 103a extends through a front portion of a left wall, a second intake port 103b extends through a rear wall, and a discharge port 103c extends through a front wall. The first intake port 103a, the second intake port 103b, and the discharge port 103c are located at the same height in the vertical direction.

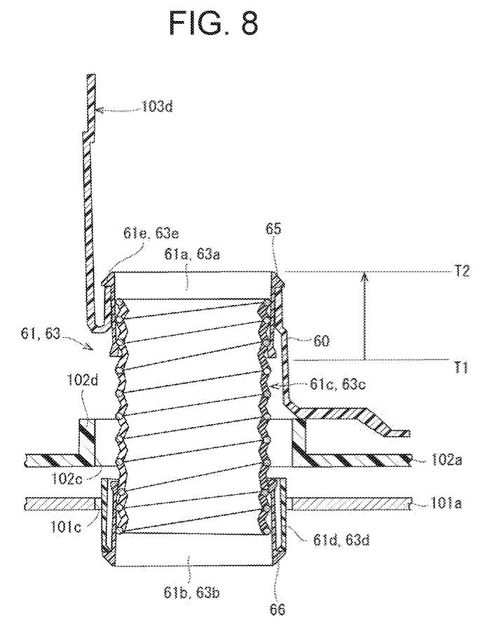

A duct recess portion 103d is formed in the outer upper cover 103, which is recessed downward from an upper wall of the outer upper cover 103 extending horizontally. As illustrated in FIG. 8, the duct recess portion 103d has two bosses 60 each having a cylindrical shape and extending upward from a bottom surface of the outer upper cover 103 (In FIG. 8, one of the two bosses 60 is illustrated). Two outlet ports 61e, 63e, which are aligned with the outlet ports 101c, 102c, extend through upper ends of the bosses 60, respectively. As illustrated in FIG. 2, a first opening 103e and a second opening 103f extend through the upper wall of the outer upper cover 103.

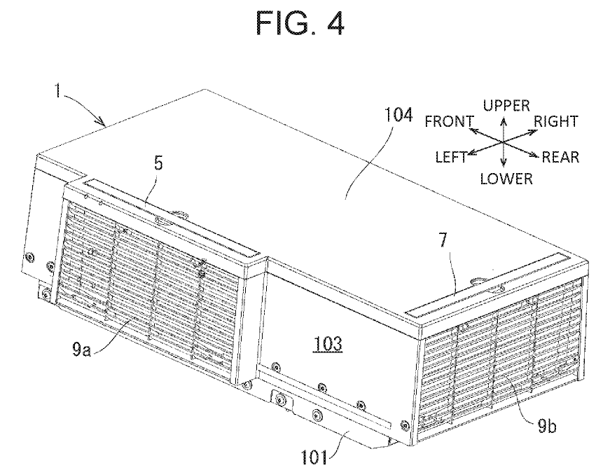

The outer top cover 104 has a plate shape, which is aligned with an upper surface of the outer upper cover 103. A sealing member (not illustrated) is disposed between the outer top cover 104 and the duct recess portion 103d of the outer upper cover 103. As illustrated in FIG. 4, the outer top cover 104 is joined to the outer upper cover 103 to form a main exterior of the unit cooler 1. As illustrated in FIG. 2, a first opening 104a that aligns with the first opening 103e of the outer upper cover 103 and a second opening 104b that aligns with the second opening 103f of the outer upper cover 103 extend through the outer top cover 104.

A first filter 5 is insertable into and removable from the first openings 104a, 103e from above. A second filter 7 is insertable into and removable from the second openings 104b, 103f from above. The first filter 5 is formed of a frame 5b in which two windows 5a are formed, meshes 5c made of metal and attached to the windows 5a, and a sponge 5d provided on an outer surface of the frame 5b. The second filter 7 is formed of a frame 7b in which two windows 7a are formed, meshes 7c made of metal and attached to the windows 7a, and a sponge 7d provided on an outer surface of the frame 7b.

When the first filter 5 is inserted into the first openings 104a, 103e, the sponge 5d and the meshes 5c cover an outside of the first intake port 103a of the outer upper cover 103. When the second filter 7 is inserted into the second openings 104b, 103f, the sponge 7d and the meshes 7c cover an outside of the second intake port 103b of the outer upper cover 103. A louver 9a is provided at the first intake port 103a so as to be located outside the sponge 5d. A louver 9b is provided at the second intake port 103b so as to be located outside the sponge 7d. A louver 9c is provided at the discharge port 103c.

As illustrated in FIG. 3, the base frame 11 is formed by bending and joining a plurality of metal plates. The base frame 11 has a base plate 11a having a rectangular plate shape that is long in the front-rear direction and extends horizontally, a first guide frame 11b fixed to a front end of the base plate 11a, and a second guide frame 11c fixed to a rear end of the base plate 11a. As illustrated in FIG. 6, the base frame 11 has a partition wall 11d fixed to a center of the base plate 11a. The partition wall 11d divides the base frame 11 into a front portion and a rear portion. The partition wall 11d includes a plurality of through holes (not illustrated) for assembling.

Furthermore, as illustrated in FIG. 6, a through hole 11f extends through the front portion of the base plate 11a. The section wall 102h of the inner undertray 102 is inserted into the through hole 11f. A bracket 11e has a trapezoidal shape and is fixed around the through hole 11f. Note that in FIG. 6, illustrations of the vibration-damping members 4 are omitted.

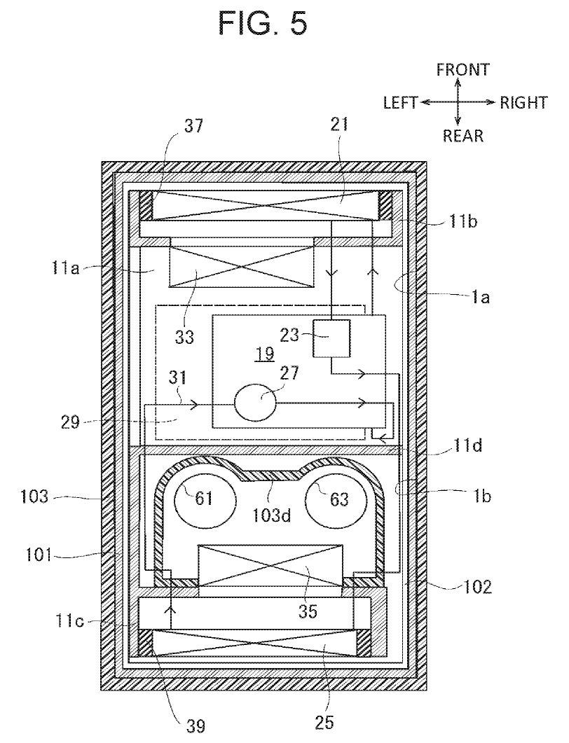

As illustrated in FIG. 3, the air conditioning unit 200 includes an electric compressor 19, a condenser 21, an expansion valve 23, the evaporator 25, an accumulator 27, and a control device 29. The expansion valve 23 corresponds to a decompression device. As illustrated in FIGS. 5 and 6, the electric compressor 19, the condenser 21, the expansion valve 23, the evaporator 25, and the accumulator 27 are connected in this order by piping 31, thereby forming a refrigeration cycle through which a refrigerant circulates. The condenser 21 and the evaporator 25 have the same rectangular parallelepiped shape.

The electric compressor 19, the condenser 21, the expansion valve 23, the evaporator 25, and the accumulator 27 are fixed to an upper surface of the base plate 11a. The electric compressor 19 is located between the condenser 21 and the evaporator 25. The electric compressor 19 is fixed to an upper surface of the bracket 11e. The control device 29 is fixed to a lower surface of the bracket 11e. The condenser 21 is fixed to the first guide frame 11b. The evaporator 25 is fixed to the second guide frame 11c.

As illustrated in FIG. 3, the air conditioning unit 200 includes a first fan 33 and a second fan 35. The first fan 33 and the second fan 35 each have a built-in motor. As illustrated in FIGS. 5 and 6, the first fan 33 is disposed between the electric compressor 19 and the condenser 21 and is fixed to the first guide frame 11b. The second fan 35 is disposed between the electric compressor 19 and the evaporator 25 and is fixed to the second guide frame 11c.

The first guide frame 11b is provided between the condenser 21 and the first fan 33 so that air sent from the first fan 33 is guided to reach the entire condenser 21. Sealing members 37 are provided between the condenser 21 and the first guide frame 11b, as well as between the first fan 33 and the first guide frame 11b, to improve airtightness.

The second guide frame 11c is provided between the evaporator 25 and the second fan 35 so that air sent from the second fan 35 is guided to reach the entire evaporator 25. Sealing members 39 are provided between the evaporator 25 and the second guide frame 11c, as well as between the second fan 35 and the second guide frame 11c, to improve airtightness.

The control device 29 has a power cord (not illustrated) connected to the battery 3b of the forklift truck 3 and a connecting cord (not illustrated) connected to the electric compressor 19, the first fan 33, and the second fan 35. The air conditioning module 300 is formed by fixing the upper frame 13 and the top frame 15 to the base frame 11 on which the air conditioning unit 200 is assembled.

As illustrated in FIGS. 2, 3, 5, and 6, in the duct recess portion 103d of the outer upper cover 103, bellows devices 61, 63, which discharge air having passed through the second fan 35 to the outside of the housing 100, are disposed between the electric compressor 19 and the second fan 35. The bellows devices 61, 63 correspond to ducts in the present disclosure. The bellows devices 61, 63 are inserted into the two outlet ports 61e, 63e. As illustrated in FIG. 8, positions T2 of the outlet ports 61e, 63e that configure the bellows devices 61, 63 are located above a lower end T1 of the second fan 35.

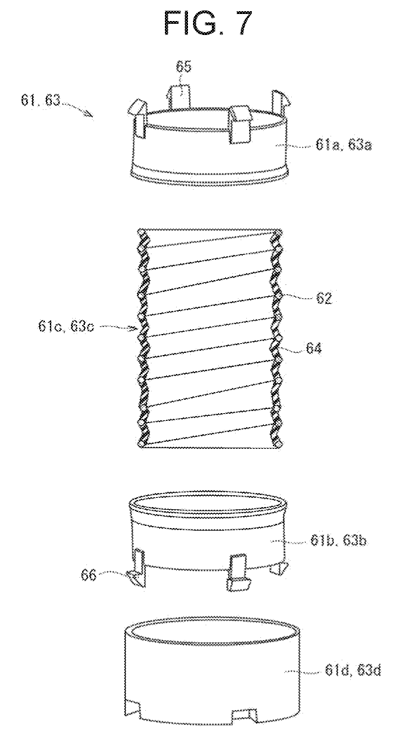

As illustrated in FIG. 7, the bellows devices 61, 63 have first cuffs 61a, 63a located in upper ends of the bellows devices 61, 63, respectively, second cuffs 61b, 63b located in lower ends of the bellows devices 61, 63, respectively, bellows hoses 61c, 63c fixed to the first cuffs 61a, 63a and the second cuffs 61b, 63b, and holders 61d, 63d fixed to the second cuffs 61b, 63b. The first cuffs 61a, 63a form one end portions of the bellows devices 61, 63, respectively. The second cuffs 61b, 63b form the other end portions of the bellows device 61, 63, respectively. The first cuffs 61a, 63a are located above the lower end T1 of the second fan 35, as illustrated in FIG. 8.

The bellows hoses 61c, 63c are each formed of a core metal 62 that has a spiral shape and a tubular member 64 that includes the core metal 62 and has a tubular shape. In an outer surface of the tubular member 64, external threads are formed by the core metal 62. Internal threads (not illustrated) are formed in inner surfaces of the first cuffs 61a, 63a and in inner surfaces of the second cuffs 61b, 63b. The external threads of the bellows hoses 61c, 63c are screwed into the internal threads of the first cuffs 61a, 63a and the second cuffs 61b, 63b, so that the first cuffs 61a, 63a and the second cuffs 61b, 63b are fixed to the bellows hoses 61c, 63c, respectively.

The first cuffs 61a, 63a each have a plurality of hooks 65 extending upward, and a distal end of each of the hooks 65 may deform elastically outwardly in a radial direction of each of the bellows hoses 61c, 63c. As illustrated in FIG. 8, the hooks 65 are engaged with the bosses 60, so that the first cuffs 61a, 63a are fixed at the outlet ports 61e, 63e of the outer upper cover 103, respectively. Accordingly, the first cuffs 61a, 63a are fixed inside the housing 100.

The second cuffs 61b, 63b each have a plurality of hooks 66 extending downward, and a distal end of each of the hooks 66 may deform elastically outwardly in the radial direction of each of the bellows hoses 61c, 63c. The hooks 66 are engaged with the holders 61d, 63d, so that the holders 61d, 63d are fixed to the second cuffs 61b, 63b, respectively. The holders 61d, 63d are formed to be easily held by a person.

In addition, the bellows hoses 61c, 63c extend from the first cuffs 61a, 63a to the second cuffs 61b, 63b and allow the cooled air to be drawn through the first cuffs 61a, 63a, to flow through an inside of the bellows hoses 61c, 63c, and to be discharged from the second cuffs 61b, 63b.

The bellows hoses 61c, 63c are extendible and contractible so that a distance between the first cuffs 61a, 63a and the second cuffs 61b, 63b is changed by changing pitch of the core metal 62. Thus, when the bellows hoses 61c, 63c are contracted, upper portions of the second cuffs 61b, 63b and the holders 61d, 63d are retracted to the inside of the housing 100 so as not to protrude out from the housing 100, in other words, when the bellows hoses 61c, 63c are most contracted, at least portions of the second cuffs 61b, 63b and the holders 61d, 63d are retracted to the inside of the housing 100, in detail, retracted to an inside of the outer undertray 101.

In this unit cooler 1, when the driver M turns on the control device 29, the electric compressor 19 compresses refrigerant, and the refrigerant then circulates to the electric compressor 19 through the condenser 21, the expansion valve 23, the evaporator 25, and the accumulator 27. With this configuration, air drawn through the second intake port 103b is cooled in the evaporator 25, and the cooled air is supplied to the driver M through the bellows devices 61, 63. The condenser 21 condenses refrigerant using air drawn through the first intake port 103a and releases heat through the discharge port 103c.

In this unit cooler 1, the driver M may change not only directions of air outlets of the second cuffs 61b, 63b, but also positions of the air outlets by holding the holders 61d, 63d and changing lengths of the bellows hoses 61c, 63c. Thus, in this unit cooler 1, the positions of the air outlets may be directed toward a neck of the driver M.

In this unit cooler 1, when the bellows hoses 61c, 63c are contracted, the upper portions of the second cuffs 61b, 63b and the holders 61d, 63d are retracted to the inside of the housing 100. As a result, the bellows hoses 61c, 63c do not bulge downward, irrespective of whether the bellows devices 61 and 63 are in use or not, thereby not causing obstruction.

In this unit cooler 1, since the positions T2 of the outlet ports 61e, 63e located in the upper ends of bosses 60 are above the lower end T1 of the second fan 35, condensate water generated in the evaporator 25 is not likely to flow into the inside of the bellows hoses 61c, 63c, thereby preventing the driver M from feeling discomfort.

In this unit cooler 1, when the first cuffs 61a, 63a are fixed to the duct recess portion 103d, the bellows devices 61, 63 may be attached to the housing 100. In addition, the positions of the air outlets may be maintained as desired using the second cuffs 61b, 63b and the holders 61d, 63d.

Therefore, in this unit cooler 1, the directions and the positions of the air outlets may be changed as desired, and the bellows devices 61, 63 do not cause obstruction.

Although the present disclosure has been described above based on the embodiment, the present disclosure is not limited to the embodiment and may be modified as appropriate within the scope of the present disclosure.

For example, the unit cooler of the present disclosure may be used in an electric forklift truck of a counter type, a picking type, a3-way type, or a refrigerator-freezer type, and may be widely used in industrial vehicles such as various engine forklift trucks, transportation equipment, or towing trucks.

This specification also includes the following disclosure.

### Additional note 1

A unit cooler comprising:

a housing in which an intake port is formed;

an air conditioning unit accommodated in the housing, forming a refrigerant cycle, configured to cool air drawn through the intake port, and configured to discharge the cooled air to an outside of the housing; and

a duct disposed in the housing and through which the air cooled by the air conditioning unit is discharged, wherein

the duct is a bellows device having one end portion and the other end portion, the bellows device allowing the cooled air to be drawn through the one end portion, to flow through an inside of the bellows device, and to be discharged from the other end portion, the bellows device being extendible and contractible so that a distance between the one end portion and the other end portion is changed,

the one end portion is fixed to an inside of the housing, and

at least a portion of the other end portion is retracted to the inside of the housing when the bellows device is most contracted.

### Additional note 2

The unit cooler according to Additional note 1, wherein

the housing includes an outer upper cover in which the intake port is formed and an outer undertray, and

at least the portion of the other end portion is retracted to an inside of the outer undertray when the duct is contracted.

### Additional note 3

The unit cooler according to Additional note 1 or 2, wherein

the air conditioning unit has an electric compressor, a condenser, a decompression device, an evaporator, a first fan that sends air to the condenser, and a second fan that sends air to the evaporator, and

the one end portion is located above a lower end of the second fan.

### Additional note 4

The unit cooler according to any one of Additional notes 1 to 3, wherein

the outer upper cover has a duct recess portion that recesses downward from an upper wall of the outer upper cover extending horizontally and to which the one end portion is fixed,

the duct recess portion includes a boss having a cylindrical shape and extending upward from a bottom surface of the outer upper cover,

an outlet port into which the duct is inserted extends through an upper end of the boss, and

the upper end of the boss is located above a lower end of the second fan.

### Additional note 5

The unit cooler according to any one of Additional notes 1 to 3, wherein

the bellows device includes:

a first cuff that is fixed to the duct recess portion;

a second cuff that forms the other end portion; and

a bellows hose that is fixed to the first cuff and the second cuff.

(Additional note 6)

The unit cooler according to any one of Additional notes 1 to 5, wherein

the second cuff has a holder to be easily held by a person.

### Industrial Applicability

The present disclosure can be used for a unit air conditioner that can be installed as an option in an industrial vehicle.

What is claimed is:

1. A unit cooler comprising:
a housing in which an intake port is formed;
an air conditioning unit accommodated in the housing, forming a refrigerant cycle, configured to cool air drawn through the intake port, and configured to discharge the cooled air to an outside of the housing; and
a duct disposed in the housing and through which the air cooled by the air conditioning unit is discharged, wherein
the duct is a bellows device having one end portion and the other end portion, the bellows device allowing the cooled air to be drawn through the one end portion, to flow through an inside of the bellows device, and to be discharged from the other end portion, the bellows device being extendible and contractible so that a distance between the one end portion and the other end portion is changed,
the one end portion is fixed to an inside of the housing, and
at least a portion of the other end portion is retracted to the inside of the housing when the bellows device is most contracted.

2. The unit cooler according to claim 1, wherein
the housing includes an outer upper cover in which the intake port is formed and an outer undertray, and
at least the portion of the other end portion is retracted to an inside of the outer undertray when the duct is contracted.

3. The unit cooler according to claim 1, wherein
the air conditioning unit has an electric compressor, a condenser, a decompression device, an evaporator, a first fan that sends air to the condenser, and a second fan that sends air to the evaporator, and
the one end portion is located above a lower end of the second fan.

4. The unit cooler according to claim 2, wherein
the outer upper cover has a duct recess portion that recesses downward from an upper wall of the outer upper cover extending horizontally and to which the one end portion is fixed,
the duct recess portion includes a boss having a cylindrical shape and extending upward from a bottom surface of the outer upper cover,
an outlet port into which the duct is inserted extends through an upper end of the boss, and
the upper end of the boss is located above a lower end of the second fan.

5. The unit cooler according to claim 4, wherein
the bellows device includes:
a first cuff that is fixed to the duct recess portion;
a second cuff that forms the other end portion; and
a bellows hose that is fixed to the first cuff and the second cuff.

6. The unit cooler according to claim 5, wherein
the second cuff has a holder to be easily held by a person.
